(19) United States
(12) Patent Application Publication
(10) Pub. No.: US 2008/0291912 A1
(43) Pub. Date: Nov. 27, 2008

(54) SYSTEM AND METHOD FOR DETECTING FILE

(75) Inventors: Yang-Seo CHOI, Daejeon (KR); Ik-Kyun Kim, Daejeon (KR); Dae-Won Kim, Daejeon (KR); Jin-Tae Oh, Daejeon (KR); Jong-Soo Jang, Daejeon (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronics and Telecommunications Research Institute, Daejeon (KR)

(21) Appl. No.: 12/044,410

(22) Filed: Mar. 7, 2008

(30) Foreign Application Priority Data
May 21, 2007 (KR) 10-2007-0049071

(51) Int. Cl. H04L 12/56

(52) U.S. Cl. 370/389

(57) ABSTRACT

The present invention relates to a file detecting system and a method thereof. The file detecting system uses a signature of a file header and collects a network packet including a file to be detected among packets transmitted/received through a network. Subsequently, after the network protocol header is eliminated from the collected network packet, the file is reassembled and recovered. The recovered file is verified, and the verified file is transmitted to various file analysis systems.

This application claims priority to and the benefit of Korean Patent Application No. 10-2007-0049071 filed in the Korean Intellectual Property Office on May 21, 2007, the entire contents of which are incorporated herein by reference.

### BACKGROUND OF THE INVENTION

(a) Field of the Invention

The present invention relates to a file detecting system and a method thereof. More particularly, the present invention relates to a file detecting system for detecting and reconstruction a file from a network packet transmitted/received in a network, and a method thereof.

This work was supported by the IT R&D program of MIC/IITA [2006-S-042-02, Development of Signature Generation and Management Technology against Zero-day Attack].

(b) Description of the Related Art

A conventional system for detecting a file in a network is used for limited applications, and it determines whether a network packet includes predetermined strings that are included in the particular file to be detected so as to determine whether the file is transmitted to the network. Accordingly, a file detecting operation is performed according to the predetermined strings for each file, and therefore the amount of information to be obtained is limited, and accuracy is also low.

In addition, since only the conventional file detecting system determines whether a file is included in a network packet, even when a virus blocking system is informed that the file is included in the network packet, the virus blocking system is required to recover the file and analyze the recovered file to obtain information, and therefore a preparing time is delayed, and it may be difficult to reduce damage caused by the file. As described, the conventional detecting system for simply detecting the file from the network packet and transmitting the detecting result may cause file analysis delay in an analysis system.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a file detecting system for collecting a network packet corresponding to a file to be analyzed among network packets transmitted/received through a network, and reassembling the file from the collected network packet, and a method thereof.

According to an exemplary embodiment of the present invention, in a file detecting method of a file detecting system connected to a network, network packets are collected, a file network packet including a file of a desired file type is extracted from the collected network packets based on a signature of a file header of the file, and the file is recovered by using the file network packet.

According to another exemplary embodiment of the present invention, a file detecting system includes a packet analysis device and a file recovery device. The packet analysis device collects network packets and extracts a file network packet including a file of a desired file type from the collected network packets based on a signature of a file header of the file. The file recovery device reassembles the file network packet based on file header information included in the file network packet to recover the file.

### BRIEF DESCRIPTION OF THE DRAWINGS

FIG. 1 is a configuration diagram of a file detecting system according to an exemplary embodiment of the present invention.

FIG. 2 is a configuration diagram of a packet analysis device according to the exemplary embodiment of the present invention.

FIG. 3 is a diagram representing an example of a file header configuration according to the exemplary embodiment of the present invention.

FIG. 4 is a diagram representing an example of a signature in a network packet according to the exemplary embodiment of the present invention.

FIG. 5 is a configuration diagram of a file restoring device according to the exemplary embodiment of the present invention.

FIG. 6 is a diagram representing an example of a file divided into at least one network packet to be transmitted through a network according to the exemplary embodiment of the present invention.

FIG. 7 is a diagram representing an example of a file divided into at least one network packet to be transmitted through the network according to the exemplary embodiment of the present invention.

FIG. 8 is a diagram representing files included in the network packet shown in FIG. 6 and FIG. 7.

FIG. 9 is a diagram representing an example of an application protocol header according to the exemplary embodiment of the present invention.

FIG. 10 is a flowchart representing a method for detecting a desired type file from the network packet collected by the packet analysis device according to the exemplary embodiment of the present invention.

FIG. 11 is a flowchart representing a file recovery method for recovering a file by using the network packet including the file desired by the file restoring device according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” and “comprising” will be understood to imply the inclusion of stated elements but not the exclusion of any other elements. The terms “unit”, “module”, and “block” used herein mean one unit that processes a specific function or operation, and may be implemented by hardware, software, or a combination thereof.

A packet analysis device according to an exemplary embodiment of the present invention will now be described with reference to the figures.

In the exemplary embodiment of the present invention, an executable file is exemplified as a file to be detected, but it is not limited thereto, and files having defined file headers may be used.

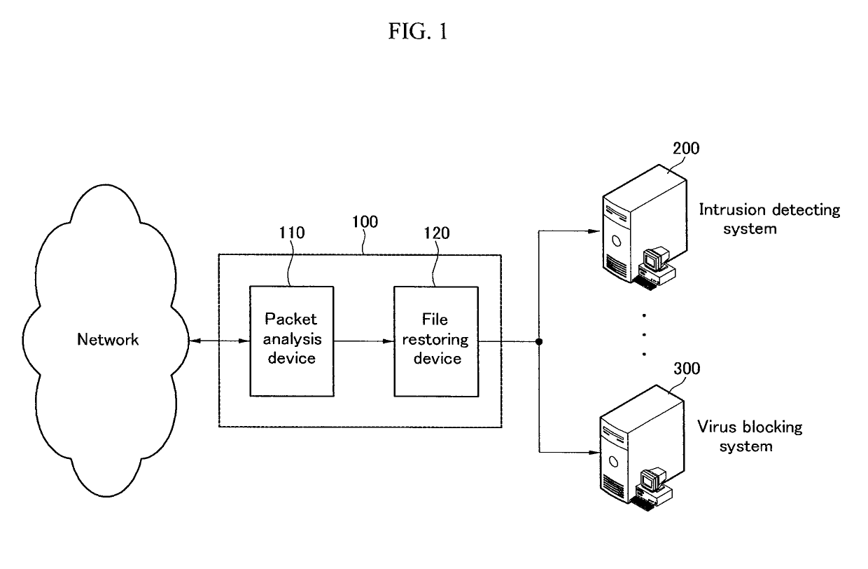

FIG. 1 is a configuration diagram of a file detecting system 100 according to an exemplary embodiment of the present invention.

Referring to FIG. 1, the file detecting system 100 includes a packet analysis device 110 and file restoring device 120.

The packet analysis device 110 collects network packets transmitted/received through a network, and extracts file network packets including a packet corresponding to a predetermined file type to be analyzed from the network packets. In addition, the packet analysis device 110 transmits a data packet separated by eliminating a network protocol header from the extracted file network packet, and file header information required to recover a file to the file restoring device 120.

The file restoring device 120 recovers the file by using the corresponding data packet and the file header information, and performs accuracy verification of the corresponding file.

The file is transmitted to various file analysis systems such as an intrusion detecting system 200 and a virus blocking system 300, and the corresponding systems perform hacking prevention or virus detection to perform detailed analysis for the transmitted file.

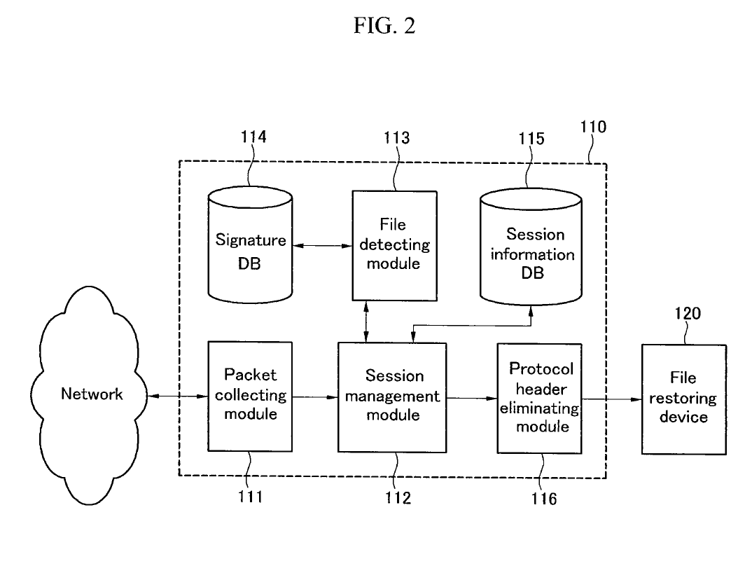

The packet analysis device 110 according to the exemplary embodiment of the present invention will now be described with reference to FIG. 2 to FIG. 4.

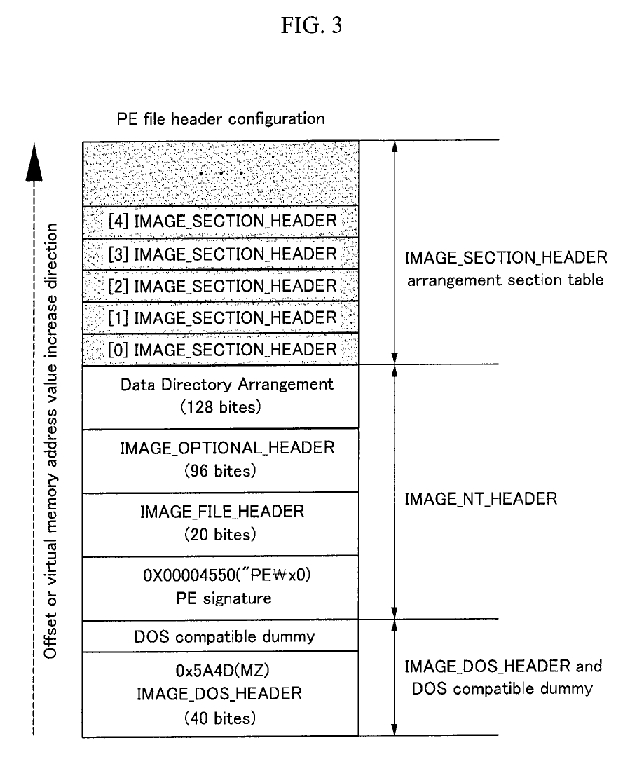

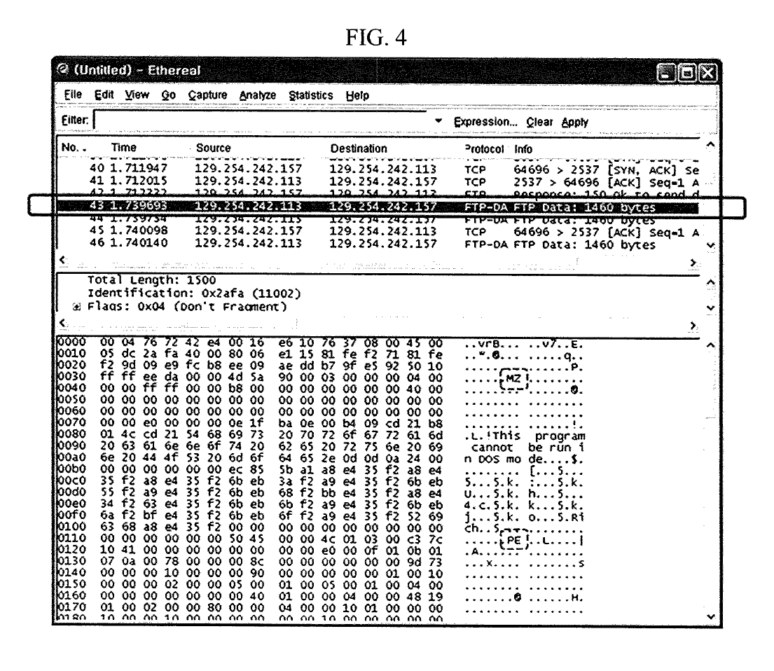

FIG. 2 is a configuration diagram of the packet analysis device 110 according to the exemplary embodiment of the present invention, FIG. 3 is a diagram representing an example of a file header configuration according to the exemplary embodiment of the present invention, and FIG. 4 is a diagram representing an example of a signature in a network packet according to the exemplary embodiment of the present invention.

Referring to FIG. 2, the packet analysis device 110 includes a packet collecting module 111, a session management module 112, a file detecting module 113, a signature database (DB) 114, a session information DB 115, and a protocol header eliminating module 116.

The packet collecting module 111 collects network packets transmitted/received through a network, and transmits the collected network packets to the session management module 112.

The session management module 112 classifies file network packets including a file of a desired type from the collected network packets. To do so, the session management module 112 uses session information stored in the session information DB 115 to classify a network packet belonging to a session of collecting packets from the collected network packets, and transmits the network packet to the protocol header eliminating module 116. In the session of collecting the packet, since the network packets included in the corresponding session are determined to include the file of the desired type, the corresponding network packets are classified as file network packets.

However, when the packet is not included in the session of collecting the packet, the session management module 112 transmits the corresponding network packet to the file detecting module 113. Subsequently, the file detecting module 113 transmits information on the network packet including the file of the desired type among the network packets transmitted in a detecting process, and the session management module 112 classifies the file network packet and transmits the file network packet to the protocol header eliminating module 116. In addition, with respect to the session to which the corresponding file network packet belongs, corresponding session information is stored in the session information DB 115 so that the network packets are continuously collected without the file detecting process.

When the network packet is transmitted from the session management module 112, the file detecting module 113 uses a signature stored in the signature DB 114 to detect the file of the desired type in the corresponding network packet, and transmits a detection result to the session management module 112.

The signature DB 114 stores a signature of a file header previously formed to be used to perform the file detection process. Files used in a computer are required to have information on the files at a starting point of the file to be appropriately executed, and the information is required as a file header. In addition, when the file is used in a predetermined application program, the file header may include information for indicating that the file is used in the corresponding application program. The file header is defined by an operating system, and a user is required to use the defined file header to appropriately generate and use the file. In the exemplary embodiment of the present invention, a part always having a fixed value among the file headers is used as a signature to detect a desired file.

Referring to FIG. 3, in an exemplified header of a portable executable (PE) file used in a Microsoft Windows operating system , predetermined file header parts are set as the signatures such as “0x5A4D(MZ)” of an IMAGE_DOS_HEADER part and “0x00004550 00PE” that is a PE signature of IMAGE_NT_HEADERS. In addition, FIG. 4 shows signatures from packets transmitted/received through the network. The network packets shown in FIG. 4 are collected while a “NOTEPAD.EXE” program that is basically provided in the Windows operating system is transmitted through file transfer protocol (FTP), and “MZ” and “PE” parts may be detected from the corresponding network packet. The signature DB 114 extracts a predetermined signature from information in the file header of the desired type file to define a predetermined file and stores the signature, and the file detecting module 113 uses the signature to determine whether the corresponding file is included in the network packet.

In addition, the signature is established and stored in a system design process, and in a predetermined application protocol, an encoding process used in the application protocol is performed to generate the signature. Here, the encoding processes of the application protocol such as UNICODE and MIME of SMTP and BASE64 are well known to a person of ordinary skill in the art, and therefore detailed descriptions thereof will be omitted. In addition, the signature may be formed as a similar type to a signature used to detect an intrusion file in a conventional intrusion detecting system.

Referring back to FIG. 2, the protocol header eliminating module 116 eliminates a network protocol header corresponding to network protocols (Ethernet, IP, TCP, and UDP) from the file network packet transmitted from the session management module 112, separates a data packet corresponding to a data payload of the corresponding file network packet, and transmits a file header required to form a file by using the separated data packet to the file restoring device 120.

Table 1 shows an example of information included in the file header transmitted to the file restoring device 120. The information included in the file header transmitted to the file restoring device 120 may be eliminated or added when necessary.

TABLE 1
File header information

| No | Information |
|---|---|
| 1 | Source IP address |
| 2 | Destination IP address |
| 3 | Source Port number |
| 4 | Destination Port number |
| 5 | Network protocol information |
| 6 | Packet division information |
| 7 | Packet sequence number |
| 8 | Application protocol information |
| 9 | Etc. |

The file header information formed as shown in Table 1 is used to determine which file corresponds to the data packet transmitted from the file restoring device 120 or whether the packet is required to be encoded, and particularly, the packet sequence number is used in a process for sequentially assembling the data packets transmitted from the file restoring device 120.

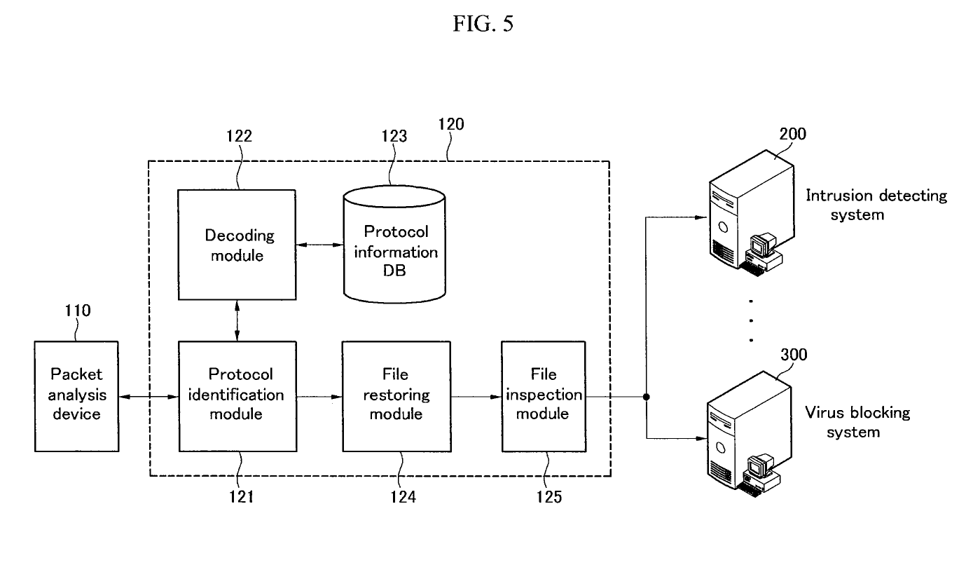

The file restoring device 120 according to the exemplary embodiment of the present invention will now be described with reference to FIG. 5 to FIG. 9.

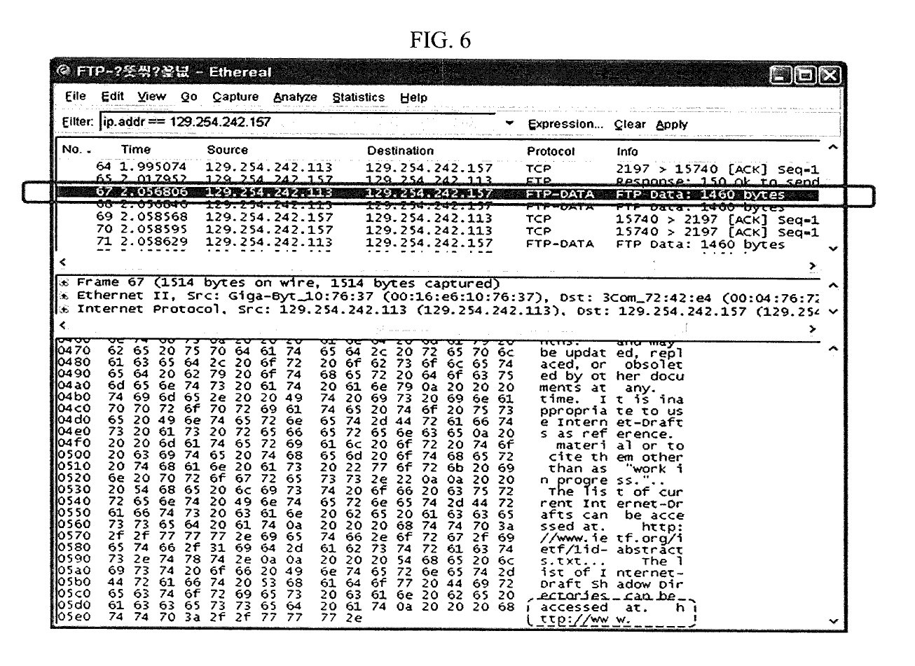

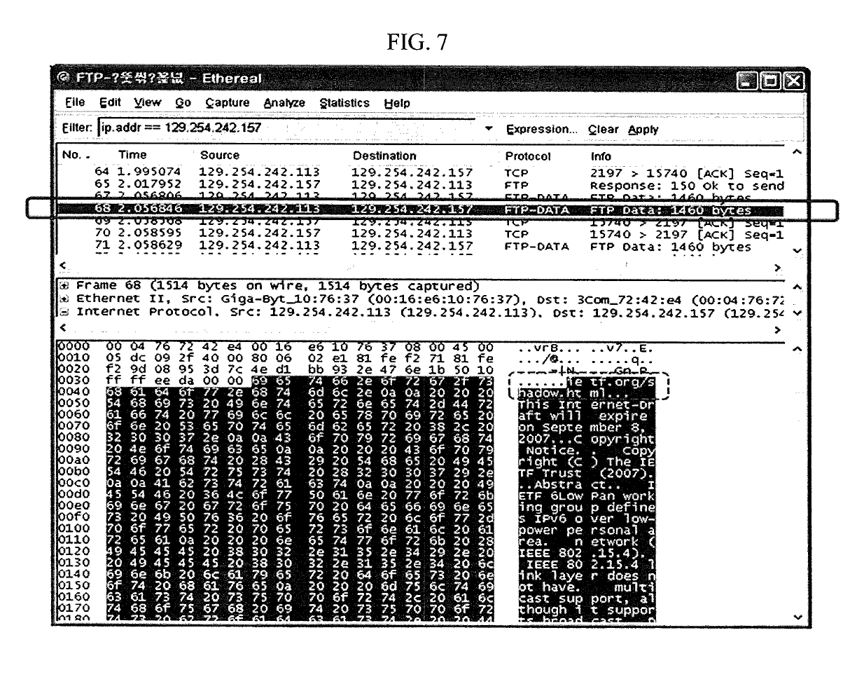

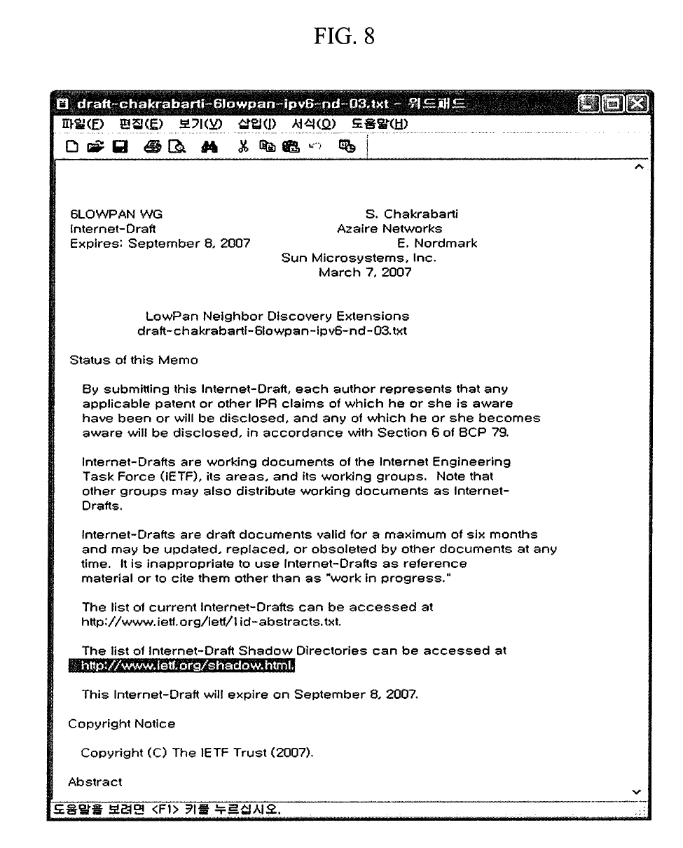

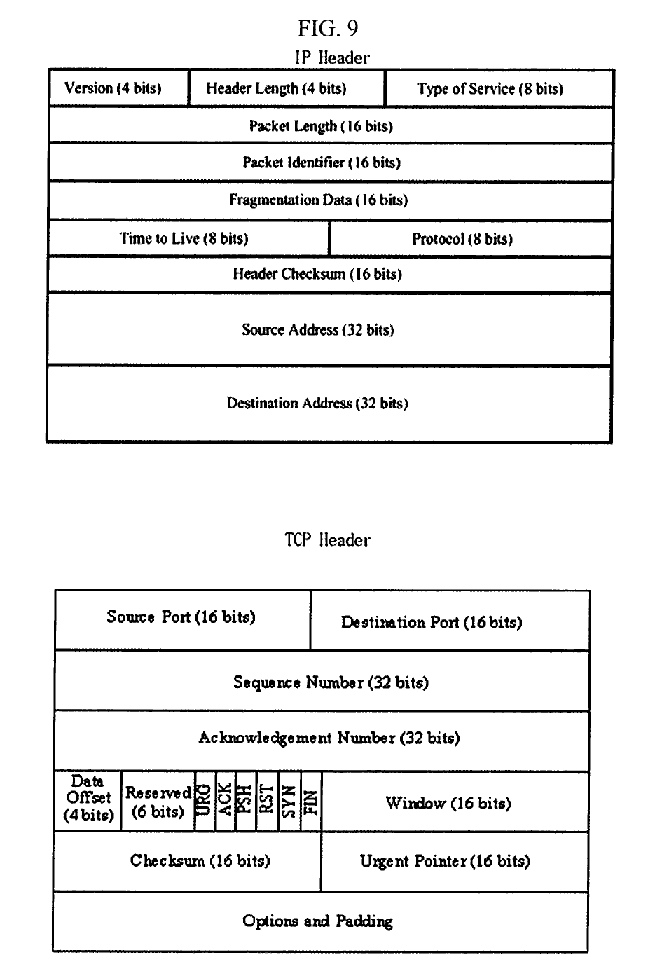

FIG. 5 is a configuration diagram of the file restoring device 120 according to the exemplary embodiment of the present invention, FIG. 6 and FIG. 7 are diagrams representing examples of files divided into at least one network packet to be transmitted through the network according to the exemplary embodiment of the present invention, and FIG. 8 is a diagram representing files included in the network packet shown in FIG. 6 and FIG. 7. FIG. 9 is a diagram representing an example of an application protocol header according to the exemplary embodiment of the present invention.

Referring to FIG. 5, the file restoring device 120 includes a protocol identification module 121, a decoding module 122, a protocol information DB 123, a file restoring module 124, and a file inspection module 125.

The protocol identification module 121 determines an application program using the data packet based on the file header transmitted from the packet analysis device 110, and transmits the data packet to the file restoring module 124 when an additional decoding process is not required. However, when the additional decoding process is required, the protocol identification module 121 transmits the corresponding data packet to the decoding module 122, receives a decoded packet from the decoding module 122, and transmits the decoded packet to the file restoring module 124.

The decoding module 122 receives the data packet that is required to be decoded from the protocol identification module 121, and decodes the data packet by using decoding information of an application protocol corresponding to the corresponding data packet among decoding information of application protocols stored in the protocol information DB 123. In this case, the application protocol required to be decoded with respect to the data packet in the decoding module 122 includes MIME and UNICODE of SMTP, and BASE64.

The protocol information DB 123 stores the decoding information for a predetermined application protocol. In this case, the predetermined application protocol storing the decoding information is encoded when a network packet is generated.

The file restoring module 124 receives the data packet and the file header from the protocol identification module 121, and forms the data packet to be a file based on the file header. In addition, since the file transmitted through the network is generally greater than 1500 bytes, the file may not be included in one network packet. Accordingly, the file is divided through a plurality of network packets to be transmitted, and in this case, the divided files are sequentially transmitted. FIG. 6 and FIG. 7 show one file divided into a plurality of network packets to be transmitted. That is, FIG. 6 and FIG. 7 show how the file is positioned in the network packet while the file shown in FIG. 8 is transmitted through the network. The last part of a data area of packet number 67 shown in FIG. 6 includes “http://www.”, and the first part of a data area of packet number 68 shown in FIG. 7 includes “ietf.org/shadow.html”. That is, as shown in FIG. 8, an “http://www.ietf.org/shadow.html” part (i.e., a highlighted part) is divided to be transmitted. Accordingly, since the corresponding file is divided into the network packets shown in FIG. 6 and FIG. 7 to be transmitted, the file restoring module 124 eliminates a network protocol header part of the corresponding network packets and reassembles it to reorganize a file.

In addition, the file restoring module 124 does not sequentially assemble the received data packets but acknowledges an order of the data packet from the received file header to reorganize the data packets. In this case, data packet order information used in file recovery information may vary according to the network protocol. For example, as shown in FIG. 9, IP header fragment data information is used in file transfer using the UDP, and TCP header sequence number information is used in file transfer using the TCP to reorganize the file. When the file is reorganized in this method, there is a merit in that the file may be reassembled in the file transfer order that is intended by a user.

Referring back to FIG. 5, the file inspection module 125 performs file accuracy verification to determine whether the file reassembled by the file restoring module 124 is appropriately generated, and transmits the verified file to systems for performing file analysis such as the intrusion detecting system 200 and the virus blocking system 300. Here, the file accuracy verification is performed to analyze, based on information in a file header, that information of the corresponding file header is equivalent to the reassembled file. Unlike the file signature, to perform the file accuracy verification, the file inspection module 125 uses variable values (information) of the file header. For example, names of respective sessions are stored in IMAGE_SECTION_HEADER of the PE file header, the same name as the corresponding name is required to be stored at a starting point of each section, and therefore the file inspection module 125 may determine whether all the files are appropriately reassembled.

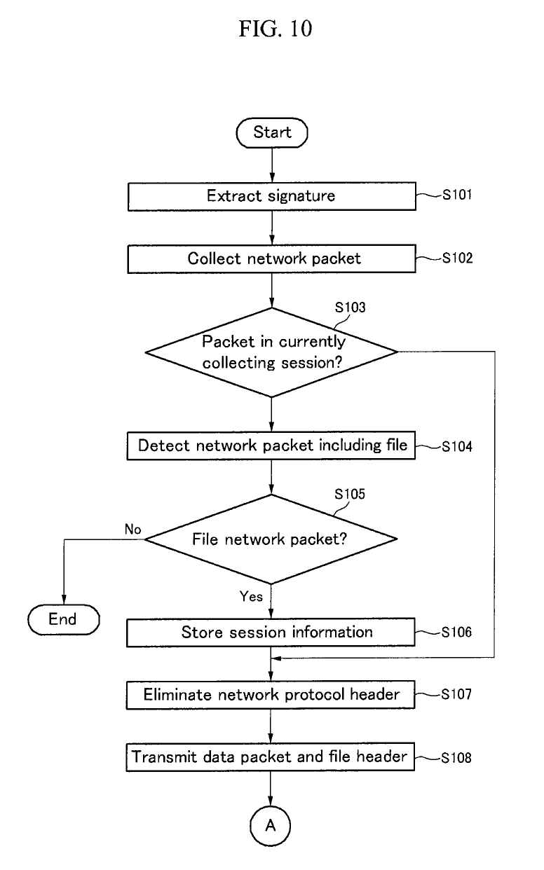

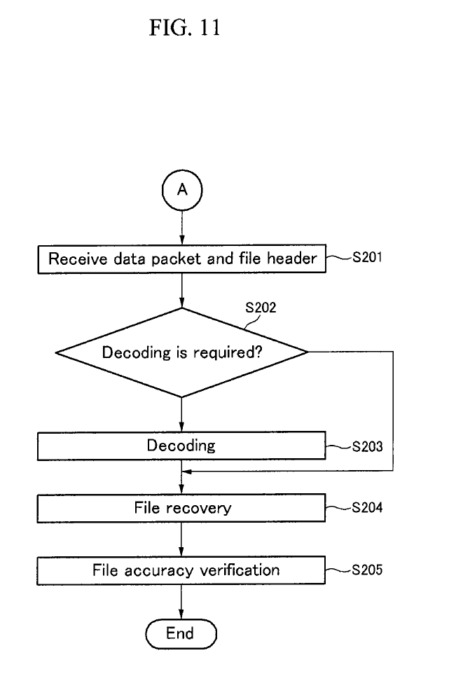

A file detecting method according to the exemplary embodiment of the present invention will now be described with reference to FIG. 10 and FIG. 11.

FIG. 10 is a flowchart representing a method for detecting a desired type file from the network packet collected by the packet analysis device 110 according to the exemplary embodiment of the present invention, and FIG. 11 is a flowchart representing a file recovery method for recovering a file by using the network packet including the file desired by the file restoring device 120 according to the exemplary embodiment of the present invention.

Referring to FIG. 10, to extract the network packet including the file to be analyzed among the network packets transmitted/received through the network, the packet analysis device 110 extract the signature from the file header of the corresponding file and stores the signature in the signature DB 114 in step S101.

The packet analysis device 110 that has selected the file type and extracted the signature according to the file type is connected to the network to collect the network packets in step S102, and determines whether the collected network packets are included in a session of currently collecting the packets in step S103.

When it is determined that the network packets are not included in the session of currently collecting the packets, the packet analysis device 110 uses the stored signature to detect the file network packet including the file of the desired type from the collected packets in step S104. That is, the packet analysis device 110 detects the network packet including the file header including the stored signature from the collected network packets.

After the detecting operation is finished, the packet analysis device 110 stores information on a session corresponding to the detected file network packet So that the network packet may be continuously collected without the file detecting operation with respect to the session in steps S105 and S106.

Subsequently, the packet analysis device 110 eliminates the network protocol header from the detected file network packet to separate the data packet in step S107, and transmits the separated data packet and the file header required to reassemble the file to the file restoring device 120 in step S108.

In addition, the packet analysis device 110 omits the file detecting operations as shown in steps S104 to S106 with respect to the session of collecting the packets, and immediately eliminates the network protocol header to separate the data packet in step S107, since the network packets in the session of collecting the packet are the file network packets including the file of the desired type.

Referring to FIG. 11, when the file restoring device 120 receives the data packet and the file header from the packet analysis device 110 in step S201, it identifies an application protocol of the corresponding data packet. The file restoring device 120 identifies the application protocol corresponding to the data packet to determine in step S202 whether the data packet is required to be decoded, and decodes the data packet by using a decoding method corresponding to the application protocol in step S203 when the decoding is required. Subsequently, the file restoring device 120 performs the file recovery by using the data packet decoded based on the file header in step S204.

In addition, when the application protocol corresponding to the data packet is not required to be decoded, the file restoring device 120 omits the decoding process shown in step S203, and immediately uses the data packet and the file header to perform the file recovery in step S204.

After the file reassemble is finished, the file restoring device 120 performs the file accuracy verification in step S205, and transmits the file to the intrusion detecting system 200 and the virus blocking system 300 that perform the additional analysis functions.

As described above, since the file detecting system according to the exemplary embodiment of the present invention may detect the file of the desired type from the network packet by using the signature of the file header of the file to be analyzed, it may detect files having fixed file headers, and therefore system flexibility may increase.

In addition, when the file required to be analyzed is detected by the file detecting system, the file is recovered and transmitted to an analysis system, and therefore the analysis system may quickly analyze the file. Therefore, when the file is abnormal it is blocked, and damage caused by the file may be reduced.

For example, since devices for analyzing files in a predetermined system to block a virus such as a virus blocking device may eliminate the virus file when the virus file exists in the predetermined system, the virus file may be eliminated after the predetermined system is infected by the virus. However, in the file detecting method according to the exemplary embodiment of the present invention, before the file arrives at the system, the file is analyzed, the virus file is quickly collected, and therefore available damage may be minimized.

The exemplary embodiment of the present invention that has been described above may be implemented by not only an apparatus and a method but also a program capable of realizing a function corresponding to the structure according to the exemplary embodiment of the present invention and a recording medium having the program recorded therein. It can be understood by those skilled in the art that the implementation can be easily made from the above-described exemplary embodiment of the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to the exemplary embodiment of the present invention, the file detecting system for collecting the file of the desired type from the network packet by using the signature of the file header of the file may be applied to all file types having fixed file headers, and therefore system flexibility may increase.

In addition, when the file required to be analyzed is detected by the file detecting system, the file is immediately recovered and transmitted to the analysis system, and therefore the analysis system may quickly analyze the corresponding file. Therefore, when the file is abnormal it is blocked, and damage caused by the file may be reduced.

What is claimed is:

1. A file detecting method of a file detecting system connected to a network, comprising:
collecting network packets;
extracting a file network packet including a file of a desired file type from the collected network packets based on a signature of a file header of the file; and
recovering the file by using the network packets.

2. The file detecting method of claim 1, further comprising comparing the recovered file and file header information of the file network packet to verify the recovered file.

3. The file detecting method of claim 1, wherein the extracting of the file network packet comprises:
determining whether a collected network packet is a network packet included in a session of currently collecting packets;
selecting the network packet included in the session from among the collected network packets to be the file network packet; and
selecting the network packet including the file of the desired file type from among network packets that are not included in the session to be the file network packet.

4. The file detecting method of claim 3, wherein the selecting of the network packet including the file of the desired file type to be the file network packet comprises selecting the network packet including a file header including the signature from the network packets that are not included in the session to be the file network packet.

5. The file detecting method of claim 1, wherein the recovering of the file comprises:
eliminating a network protocol header from a file network packet to separate a data packet; and
reassembling the data packet based on a file header included in the file network packet to recover the file.

6. The file detecting method of claim 5, wherein the reassembling of the data packet to recover the file comprises:
decoding the data packet when the data packet is an encoded packet; and
reassembling the decoded data packet to recover the file.

7. The file detecting method of claim 5, wherein the file header comprises at least one among a source Internet protocol (IP) address, a destination IP address, a source port number, a destination port number, network protocol information, packet division information, a packet sequence number, and application protocol information.

8. The file detecting method of claim 1, wherein the signature corresponds to a part having a fixed value among the file header of the file of the desired file type.

9. A file detecting system comprising:
a packet analysis device for collecting a network packet and extracting a file network packet including a file of a desired file type from collected network packets based on a signature of a file header of the file; and
a file recovery device for reassembling the file network packet based on file header information included in the file network packet to recover the file.

10. The file detecting system of claim 9, wherein the packet analysis device comprises:
a signature database for storing the signature;
a packet collecting module for collecting the network packet;
a file detecting module for determining whether the collected network packet includes a file header including the signature and outputting a determination result; and
a session management module for classifying the file network packet from the collected network packets according to the determination result and outputting the file network packet.

11. The file detecting system of claim 10, wherein the packet analysis device further comprises a session information database for storing information of a session currently collecting packets, and the session management module classifies a network packet included in the session among the collected network packets to be the file network packet and outputs the file network packet.

12. The file detecting system of claim 9, wherein the file recovery device comprises:
a protocol information database for storing decoding information of at least one application protocol;
a decoding module for decoding the file network packet required to be decoded among the file network packets by using the decoding information stored in the protocol information database, and outputting the decoded file network packet; and
a protocol identification module for identifying an application protocol corresponding to the file network packet received from the packet analysis device, outputting the file network packet required to be decoded among the file network packets to the decoding module, and outputting the file network packet that is not required to be decoded among the file network packets and the decoded file network packet received from the decoding module; and
a file recovery module for recovering the file based on file header information included in the file network packet that is not required to be decoded and the decoded file network packet and outputting the recovered file.

13. The file detecting system of claim 12, wherein the file recovery device further comprises a file inspection module for comparing the file recovered by the file recovery module to the file header information included in the file network packet that is not required to be decoded and the decoded file network packet, and verifying the file.
